(19) United States
(12) Patent Application Publication
(10) Pub. No.: US 2003/0236728 A1
(43) Pub. Date: Dec. 25, 2003

(54) Method and apparatus for managing a financial transaction system

(76) Inventors: Amir Sunderji, San Jose, CA (US); Venkatachari Dilip, Cupertino, CA (US); Sanjeev Dheer, Scarsdale, NY (US)

Correspondence Address: LEE & HAYES, PLLC, 421 W. RIVERSIDE AVE, STE 500, SPOKANE, WA, 99201, US

(21) Appl. No.: 10/402,855

(22) Filed: Mar. 28, 2003

Related U.S. Application Data
(63) Continuation-in-part of application No. 10/040,929, filed on Dec. 31, 2001.
Application No. 10/040,929 is a continuation-in-part of application No. 09/665,919, filed on Sep. 20, 2000.

(51) Int. Cl. G06F 17/60

(52) U.S. Cl. 705/35

(57) ABSTRACT

A management system identifies an account holder and identifies multiple financial accounts associated with the account holder. The multiple financial accounts are associated with at least two different financial institutions. The multiple financial accounts are then authenticated. The management system aggregates financial transaction data associated with the multiple financial accounts and displays the aggregated financial transaction data.

### RELATED APPLICATIONS

This application is a continuation-in-part of co-pending application Ser. No. 10/040,929, filed Dec. 31, 2001, entitled “Method and Apparatus for Managing Transactions”, which is a continuation-in-part of co-pending application Ser. No. 09/665,919, filed Sep. 20, 2000, entitled “Method and Apparatus for Implementing Financial Transactions”, both of which are incorporated herein by reference.

### TECHNICAL FIELD

The present invention relates to methods and systems that assist with the operation and management of a financial transaction system.

### BACKGROUND

Customers of financial institutions (both individual customers and businesses) typically maintain multiple financial accounts at one or more financial institutions. Financial institutions include, for example, banks, savings and loans, credit unions, mortgage companies, lending companies, and stock brokers. These financial accounts include asset accounts (such as savings accounts, checking accounts, certificates of deposit (CDs), mutual funds, bonds, and equities) and debt accounts (such as credit card accounts, mortgage accounts, home equity loans, overdraft protection, and other types of loans).

It is desirable to provide financial transaction systems that are capable of implementing transactions such as transfers of funds between various financial accounts at one or more financial institutions. Prior to implementing any financial transaction for a particular user or involving a particular account, it is important to authenticate the identity of the user requesting the transaction, authenticate that user's permission to implement the requested transaction, and evaluate any risks involved with the user, the requested transaction, or the accounts involved in the requested transaction.

Further, it is desirable to monitor various financial transactions and make adjustments to transaction limitations and restrictions as needed. This type of monitoring may indicate trends or potential problems for particular accounts or customers.

The systems and methods described herein assist with the handling and monitoring of various financial transactions and other functions performed by a financial transaction system.

### BRIEF DESCRIPTION OF THE DRAWINGS

FIG. 1 illustrates an exemplary network environment in which various servers, computing devices, and financial transaction systems exchange data across a network, such as the Internet.

FIG. 2 is a block diagram showing pertinent components of a computer in accordance with the invention.

FIG. 3 is a block diagram showing exemplary components and modules of a support server.

FIG. 4 is an example screen display illustrating information related to a customer profile.

FIG. 5 is a flow diagram illustrating a procedure for generating a customer profile display of the type shown in FIG. 4.

FIG. 6 is an example screen display illustrating information related to customer performance.

FIG. 7 is a flow diagram illustrating a procedure for generating a customer performance display of the type shown in FIG. 6.

FIG. 8 is an example screen display illustrating information related to identity authentication.

FIG. 9 is a flow diagram illustrating a procedure for generating an identity authentication display of the type shown in FIG. 8.

FIG. 10 is an example screen display illustrating information related to account ownership.

FIG. 11 is a flow diagram illustrating a procedure for generating an account ownership display of the type shown in FIG. 10.

FIG. 12 is an example screen display illustrating information related to risk management.

FIG. 13 is a flow diagram illustrating a procedure for generating a risk management display of the type shown in FIG. 12.

FIG. 14 is a flow diagram illustrating a procedure for shifting financial risk between to entities.

FIG. 15 is a flow diagram illustrating a procedure for aggregating financial data.

### DETAILED DESCRIPTION

The systems and methods described herein assist with processing and monitoring financial transactions and other activities performed by a financial transaction system or a financial transaction service provider. These systems and methods can aggregate various types of data from multiple sources to generate, for example, a display or report that summarizes financial transactions, account information, account status, account holder information, fees collected for various financial transactions, risk profile data and/or other information. Additionally, administrators may be permitted to modify account status information or settings based on the information received. For example, transaction limits for a particular customer may be raised or lowered based on various information and guidelines of a financial institution or other entity. If an administrator for one entity changes limits for a particular customer beyond a threshold value, financial risk for that customer's transactions may pass to the entity making the changes. These systems and methods assist with the management of financial transaction data and the handling of customers and their account privileges.

As used herein, the terms “account holder”, “customer” and “client” are interchangeable. “Account holder” refers to any person having access to an account. A particular account may have multiple account holders (e.g., a joint checking account having husband and wife as account holders or a corporate account identifying several corporate employees as account holders). Various financial account and financial institution examples are provided herein for purposes of explanation. However, it will be appreciated that the systems and procedures described herein can be used with any type of financial account or financial institution. Exemplary financial institutions include banks, savings and loans, credit unions, mortgage companies, mutual fund companies, lending companies and brokerage companies.

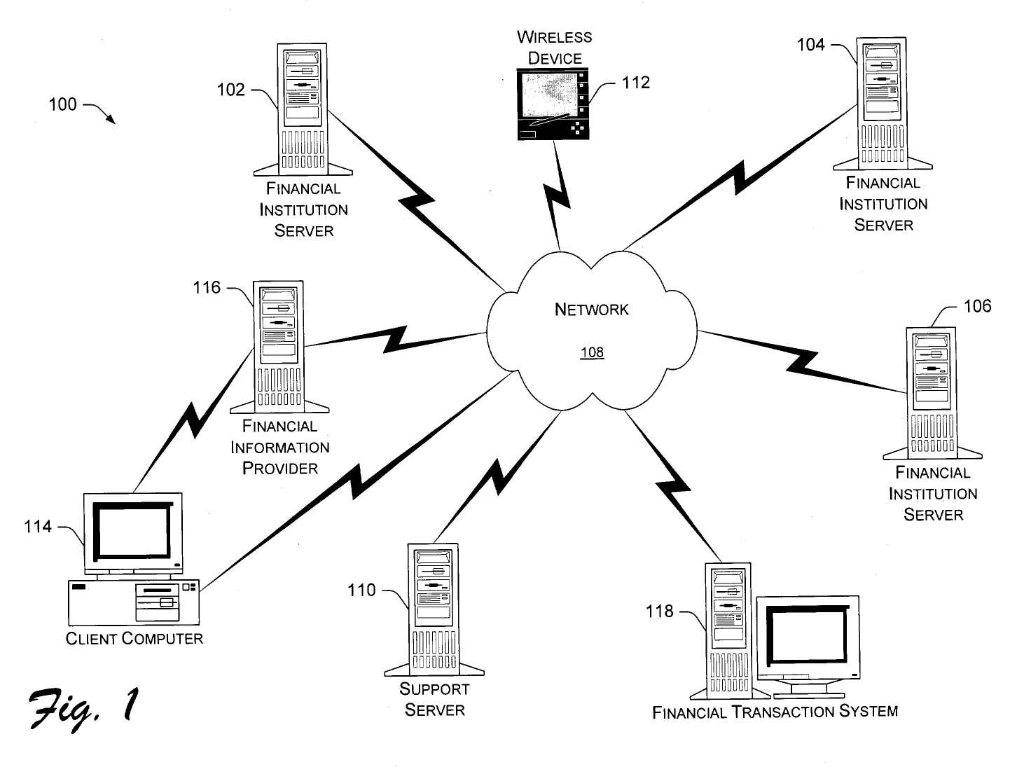

FIG. 1 illustrates an exemplary network environment 100 in which various servers, computing devices, and financial transaction systems exchange data across a data communication network. The network environment of FIG. 1 includes multiple financial institution servers 102, 104, and 106 coupled to a data communication network 108, such as the Internet. A support server 110 and a financial transaction system 118 are also coupled to network 108. Financial transaction system 118 may also be referred to as a financial management system or a financial transaction service provider.

A wireless device 112 and a client computer 114 are also coupled to network 108. Wireless device 112 may be a personal digital assistant (PDA), a handheld or portable computer, a cellular phone, a pager, or any other device capable of communicating with other devices via a wireless connection. A financial information provider 116 is coupled between network 108 and client computer 114.

Network 108 may be any type of data communication network using any communication protocol. Further, network 108 may include one or more sub-networks (not shown) which are interconnected with one another.

The communication links shown between the network 108 and the various devices (102-106 and 110-118) shown in FIG. 1 can use any type of communication medium and any communication protocol. For example, one or more of the communication links shown in FIG. 1 may be a wireless communication link (e.g., a radio frequency (RF) link or a microwave link) or a wired communication link accessed via a public telephone system, cable television system, or another communication network. Wireless device 112 typically accesses network 108 via a wireless connection to another communication network that is coupled to network 108. Certain devices, such as servers, may be coupled to a local area network (LAN), which is coupled to network 108. Client computer 114 may access network 108 in different ways. First, client computer 114 may directly access network 108, for example, by using a modem to access a public telephone network (e.g., a public switched telephone network (PSTN)) that is coupled to network 108. Alternately, client computer 114 may access financial information provider 116, which establishes or maintains a connection to network 108. Financial information provider 116 may act as a “buffer” between network 108 and client computer 114, or may allow commands and data to simply passthrough between the network 108 and the client computer 114.

Each of the financial institution servers 102, 104, and 106 are typically associated with a particular financial institution and store data for that financial institution, such as customer account data. In alternate embodiments, each financial institution server may be associated with a different financial institution.

Financial transaction system 118 performs various actions, such as financial analysis, funds transfer, customer authentication and account verification. The financial analysis actions may include analyzing one or more accounts and making recommendations to reduce service charges, reduce interest paid by a customer, or increase interest earned by a customer. Funds transfer actions include transferring funds between two or more accounts registered to the same customer or registered to different customers or entities. Funds can be transferred between two individuals or between an individual and an organization. Customer authentication and account verification actions may include authenticating the identity of an individual requesting a transaction, authenticating the individual's permission to implement the requested transaction, or evaluating risks associated with the requested transaction.

Various techniques are available to authenticate an individual and validate accounts. These techniques include, for example, verifying information provided by an individual, such as the individual's name, address, social security number, or driver's license number. Other techniques include validating address information with the United States Postal Service and validating various information with one or more credit reporting agencies or other data providers. Other data providers include, for example, data providers that collect phone numbers, cellular numbers, addresses, etc. and provide that data to others via a database or other data storage system.

Account information can be authenticated, for example, by having the individual submit a voided check, recent bank statement, or other document related to the account. Account information may also be authenticated by “harvesting” or “scraping” information from one or more web pages based on customer-provided account access information. This method of obtaining information is referred to as “data harvesting” or “screen scraping”. Various other techniques and procedures are available to authenticate a customer's identity and validate account information.

Support server 110 is capable of performing various operations that assist with the operation and management of financial transaction system 118. Additional details regarding support server 110 are discussed below. In a particular embodiment, the functions of support server 110 and financial transaction system 118 are merged into a single system. In other embodiments, a particular network environment may contain any number of support servers 110 and any number of financial transaction systems 118.

Wireless device 112 and client computer 114 allow a customer to access information via the network 108. For example, the customer can access account information from one of the financial institution servers 102, 104, or 106, or send a request for an analysis of the customer's financial accounts to financial transaction system 118. Financial information provider 116 acts as an intermediary between client computer 114 and other devices coupled to network 108. For example, client computer 114 generates a request for data or account analysis and communicates the request to the financial information provider 116. The financial information provider 116 then retrieves the requested data or initiates the requested account analysis on behalf of the user of client computer 114.

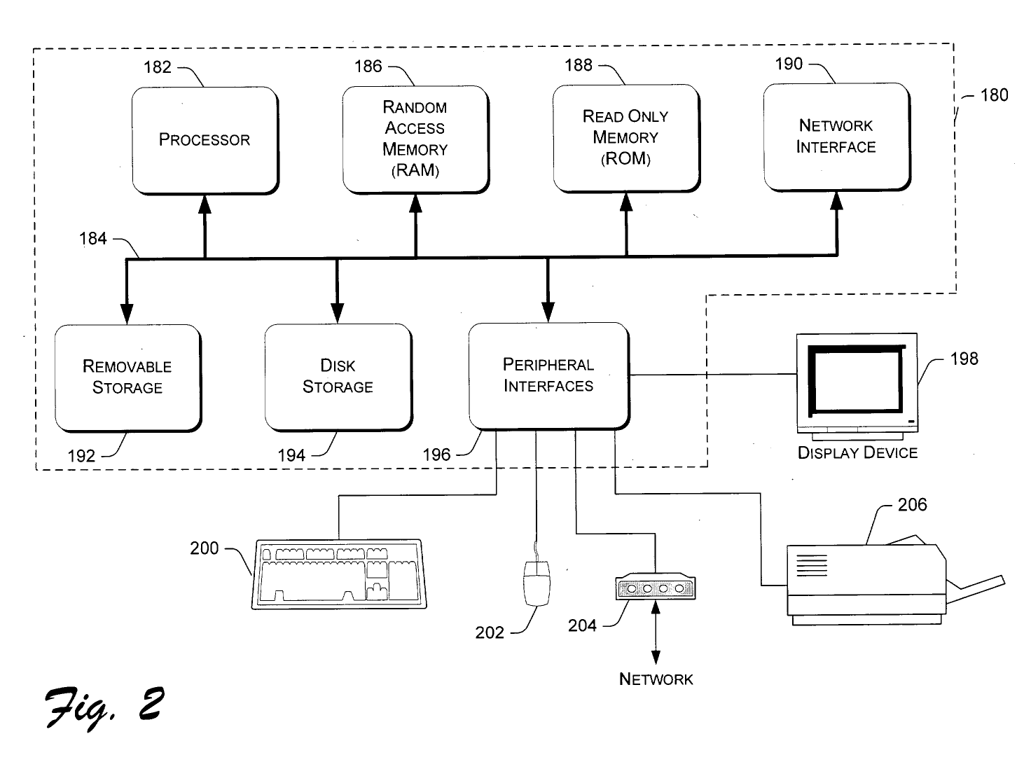

FIG. 2 is a block diagram showing pertinent components of a computer 180 in accordance with the invention. A computer such as that shown in FIG. 2 can be used, for example, to perform various operations such as accessing and analyzing account information and initiating the transfer of funds between accounts. Computer 180 can also be used to access a web site or other computing facility to access the various financial analysis functions. The computer shown in FIG. 2 can function as a server, a client computer, a support server, or a financial transaction system, of the types discussed herein.

Computer 180 includes at least one processor 182 coupled to a bus 184 that couples together various system components. Bus 184 represents one or more of any of several types of bus structures, such as a memory bus or memory controller, a peripheral bus, and a processor or local bus using any of a variety of bus architectures. A random access memory (RAM) 186 and a read only memory (ROM) 188 are coupled to bus 184. Additionally, a network interface 190 and a removable storage device 192, such as a floppy disk or a CD-ROM, are coupled to bus. 184. Network interface 190 provides an interface to a data communication network such as a local area network (LAN) or a wide area network (WAN) for exchanging data with other computers and devices. A disk storage 194, such as a hard disk, is coupled to bus 184 and provides for the non-volatile storage of data (e.g., computer-readable instructions, data structures, program modules and other data used by computer 180). Although computer 180 illustrates a removable storage 192 and a disk storage 194, it will be appreciated that other types of computer-readable media which can store data that is accessible by a computer, such as magnetic cassettes, flash memory cards, digital video disks, and the like, may also be used in the exemplary computer.

Various peripheral interfaces 196 are coupled to bus 184 and provide an interface between the computer 180 and the individual peripheral devices. Exemplary peripheral devices include a display device 198, a keyboard 200, a mouse 202, a modem 204, and a printer 206. Modem 204 can be used to access other computer systems and devices directly or by connecting to a data communication network such as the Internet.

A variety of program modules can be stored on the disk storage 194, removable storage 192, RAM 186, or ROM 188, including an operating system, one or more application programs, and other program modules and program data. A user can enter commands and other information into computer 180 using the keyboard 200, mouse 202, or other input devices (not shown). Other input devices may include a microphone, joystick, game pad, scanner, satellite dish, or the like.

Computer 180 may operate in a network environment using logical connections to other remote computers. The remote computers may be personal computers, servers, routers, or peer devices. In a networked environment, some or all of the program modules executed by computer 180 may be retrieved from another computing device coupled to the network.

Typically, the computer 180 is programmed using instructions stored at different times in the various computer-readable media of the computer. Programs and operating systems are often distributed, for example, on floppy disks or CD-ROMs. The programs are installed from the distribution media into a storage device within the computer 180. When a program is executed, the program is at least partially loaded into the computer's primary electronic memory. As described herein, the invention includes these and other types of computer-readable media when the media contains instructions or programs for implementing the steps described below in conjunction with a processor. The invention also includes the computer itself when programmed according to the procedures and techniques described herein.

For purposes of illustration, programs and other executable program components are illustrated herein as discrete blocks, although it is understood that such programs and components reside at various times in different storage components of the computer, and are executed by the computer's processor. Alternatively, the systems and procedures described herein can be implemented in hardware or a combination of hardware, software, and/or firmware. For example, one or more application specific integrated circuits (ASICs) can be programmed to carry out the systems and procedures described herein.

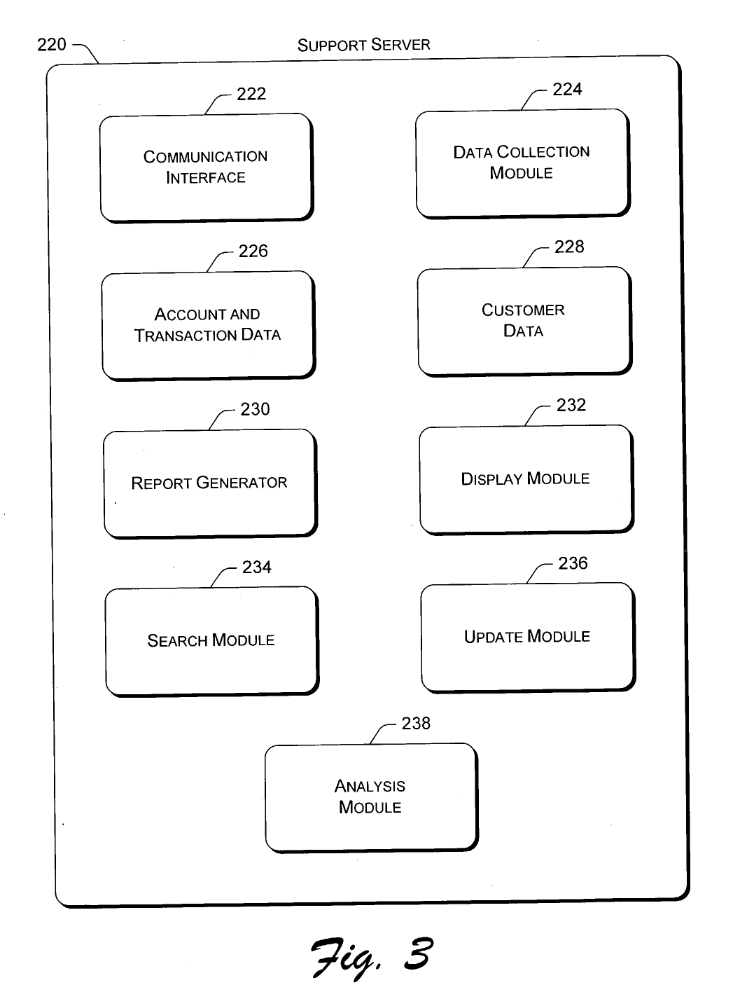

FIG. 3 is a block diagram showing exemplary components and modules of a support server 220. A communication interface 222 allows support server 220 to communicate with other computing systems, such as servers, client computers, and portable computing devices. In one embodiment, communication interface 222 is a network interface to a LAN, which is coupled to another data communication network, such as the Internet.

Support server 220 also includes a data collection module 224 that locates, identifies and retrieves data from various sources, such as financial institution databases, web pages, credit reporting agencies, driver's license databases and other data sources. The retrieved data is stored in on one or more storage devices in support server 220 or coupled to support server 220. For example, account and transaction data 226, and customer data 228 is stored on a storage device in support server 220. Account and transaction data 226 includes various account information and details regarding financial transactions implemented or handled by one or more financial transaction systems. Customer data 228 includes information such as name, address, phone number and account numbers for a particular individual or entity.

Support server 220 also includes a report generator 230 which is capable of generating reports summarizing various financial information and related data. Additional information regarding the types of data that may be included in these reports is discussed below. A display module 232 creates data that can be used to generate a display containing customer information, financial information and other data as discussed in greater detail herein.

Support server 220 further includes a search module 234, an update module 236 and an analysis module 238. Search module 234 allows a user (or administrator) of support server 220 to search for data based on customer information, account information, financial transaction type, etc. Update module 236 allows an administrator of support server to update information regarding, for example, customers, accounts and privileges. Additional details regarding updating information are discussed below. Analysis module 238 is capable of analyzing financial transactions, authentication and validation information, and other data that is provided to, for example, account holders, financial institutions and financial transaction service providers.

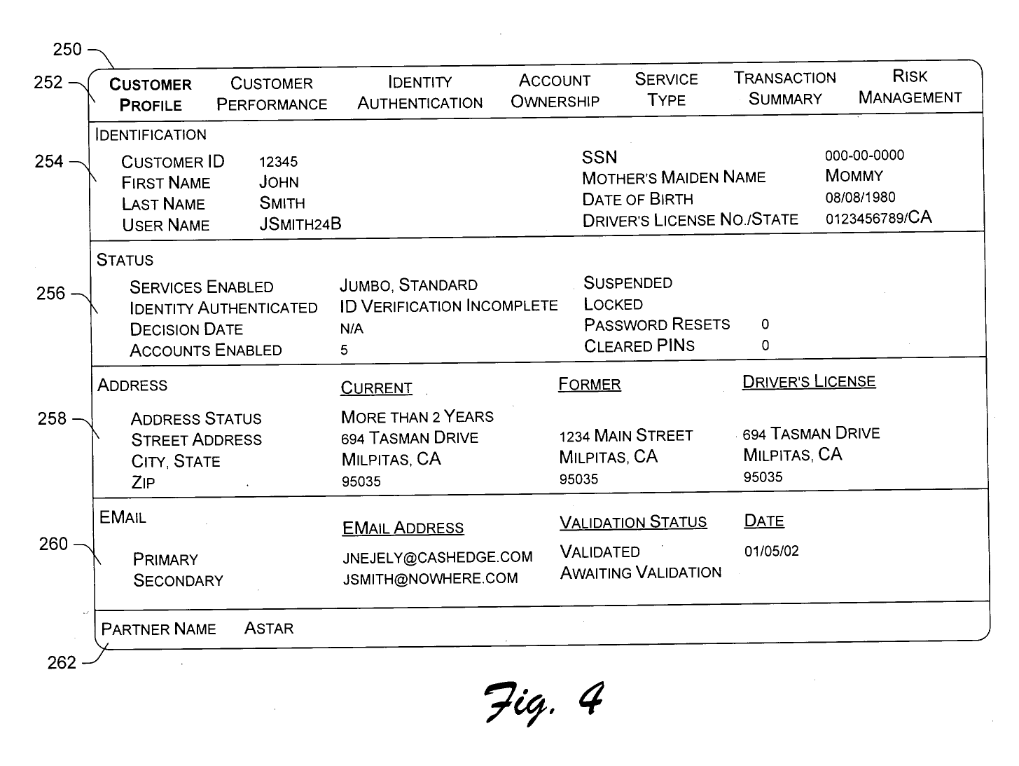

FIG. 4 is an example screen display 250 illustrating information related to a customer profile. Screen display 250 can be rendered on a computer monitor, a video projector or any other display device. Screen display 250 may be viewed as a web page via a server, printed using a printing device, or rendered using any other type of rendering device. As used herein, a “display” may also be referred to as a “page”. Particular display examples are described herein. These examples represent a particular selection and arrangement of information. It will be appreciated that the same information may be arranged in alternate formats and different selections of information may be arranged in different displays.

The customer profile screen display 250 includes a first section 252 (also referred to as a “menu bar” or “menu section”) that identifies seven categories of information that can be displayed (Customer Profile, Customer Performance, Identity Authentication, Account Ownership, Service Type, Transaction Summary and Risk Management). Certain categories in section 252 may have one or more sub-categories or sub-menus. In the example of FIG. 4, the “Customer Profile” category is shown in bold type, indicating that the “Customer Profile” category is currently selected.

The next section (section 254) contains identification information about a particular customer, John Smith. Section 254 includes the customer's identification number, social security number and other identifying information. A status section 256 identifies the status of various services and identity authentications, and information regarding the customer's accounts. Status section 256 includes a listing of services enabled for the customer. These services include, for example, standard services (i.e., standard transaction amounts and settlement times), jumbo services (higher transaction amounts and/or more frequent transactions), account-to-account transactions, NDT (next day transfer) outbound and NDT inbound services.

An address section 258 includes the customer's current and former addresses as well as the address associated with the customer's driver's license. An email section 260 identifies the customer's primary and secondary email addresses as well as the validation status of each email address. Finally, a partner name section 262 identifies a partner (e.g., another entity, such as a financial institution) through which the customer implements financial transactions such as the transfer of funds between accounts at the same or different financial institutions. Although not shown in FIG. 4, a particular customer profile may also include the customer's phone number or any other information.

Although not shown, an administrator of a support server or other system can select a particular customer to view by searching for the customer's name, address, phone number, account number, or various other customer identifiers. If the search criteria selects multiple customers, the administrator may be presented with the list of multiple customers from which the administrator selects the desired customer.

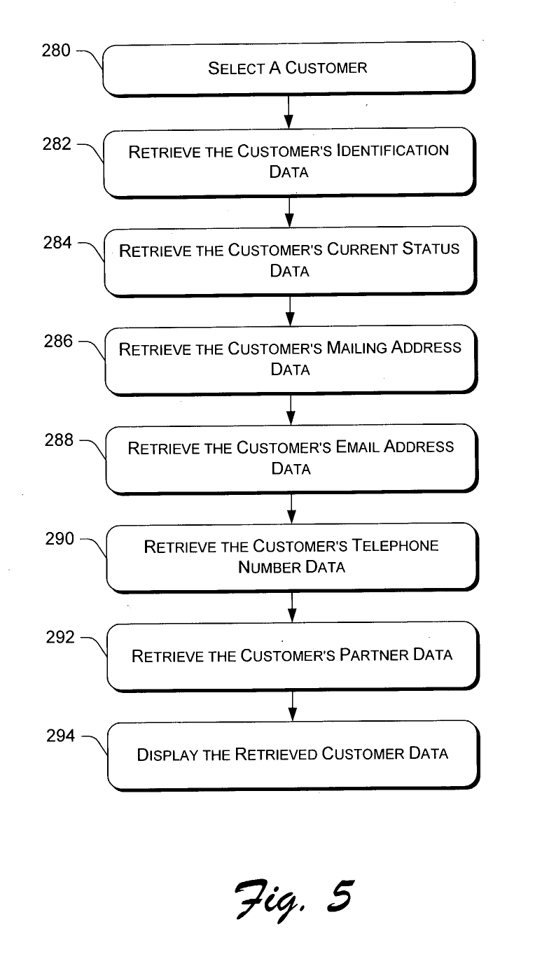

FIG. 5 is a flow diagram illustrating a procedure for generating a customer profile display of the type shown in FIG. 4. Initially, one or more customers are selected (e.g., by an administrator accessing a support server) at block 280. The procedure then retrieves the customer's identification data (block 282) and the customer's current status data (block 284). The procedure also retrieves the customer's mailing address (block 286), email address (block 288) and telephone number data (block 290). Finally, the procedure retrieves the customer's partner data (block 292) and displays the retrieved customer data (block 294), e.g., using a screen of the type shown in FIG. 4. In alternate embodiments, one or more reports are generated based on the customer profile data retrieved.

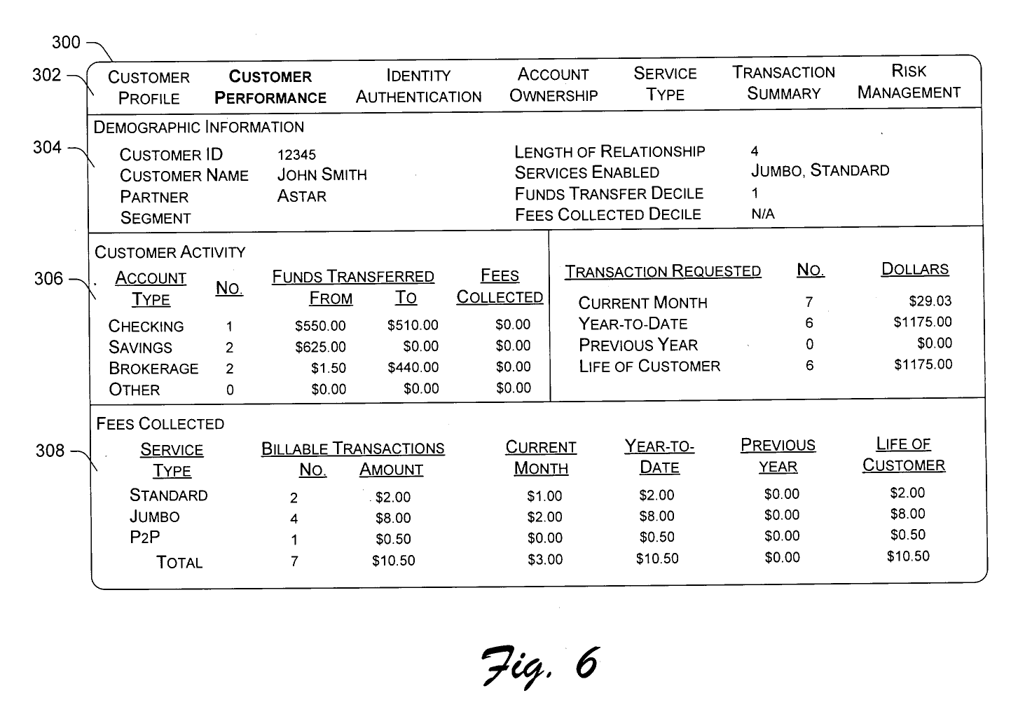

FIG. 6 is an example screen display 300 illustrating information related to customer performance. A menu section 302 shows that the category “Customer Performance” is highlighted using bold face type. A demographic information section 304 identifies the customer name, customer identifier, services enabled and other information regarding the selected customer. A customer activity section 306 identifies the customer's financial accounts and provides information about transactions associated with each of the financial accounts. Additionally, section 306 provides a summary of transactions requested by the customer during various time intervals. A fees collected section 308 identifies fees collected on behalf of a host entity over various time periods for different types of services. The fees charged to a particular user may vary from one transaction to another. For example, different fees can be charged depending on the services provided to the user, whether the transaction is an inbound transaction or an outbound transaction, the size of the transaction, and other factors. Additionally, an administrator may charge a different fee for a transaction that requires the administrator's assistance (e.g., if the administrator needs to change a limit associated with the user or override an automated decision to allow the transaction).

Although not shown in FIG. 6, alternate embodiments of display 300 include risk profile information associated with the customer and various risk actions, such as suspension of transaction privileges, associated with the customer.

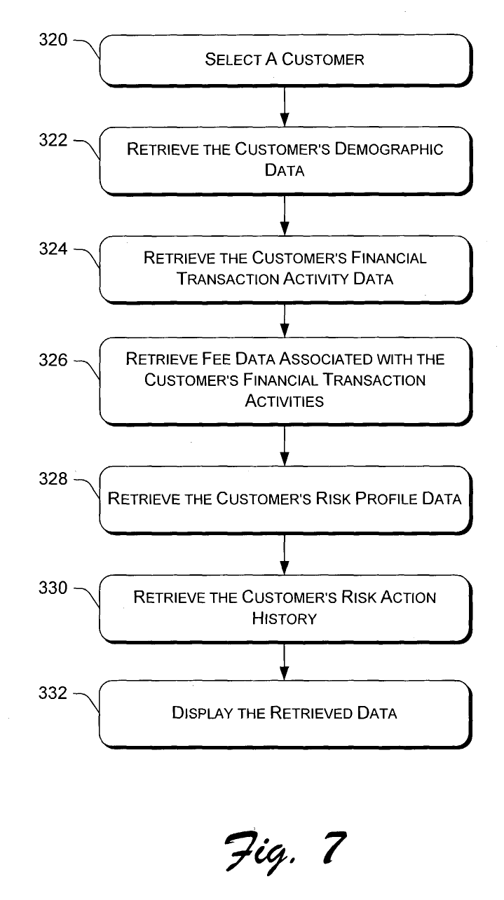

FIG. 7 is a flow diagram illustrating a procedure for generating a customer performance display of the type shown in FIG. 6. At block 320, an administrator selects a customer. The procedure continues by retrieving the customer's demographic data (block 322) and retrieving the customer's financial transaction activity data (block 324). Next, the procedure retrieves fee data associated with the customer's financial transaction activities (block 326) and retrieves the customer's risk profile data (block 328). The procedure continues by retrieving the customer's risk action history (block 330) and displaying the retrieved data (block 332).

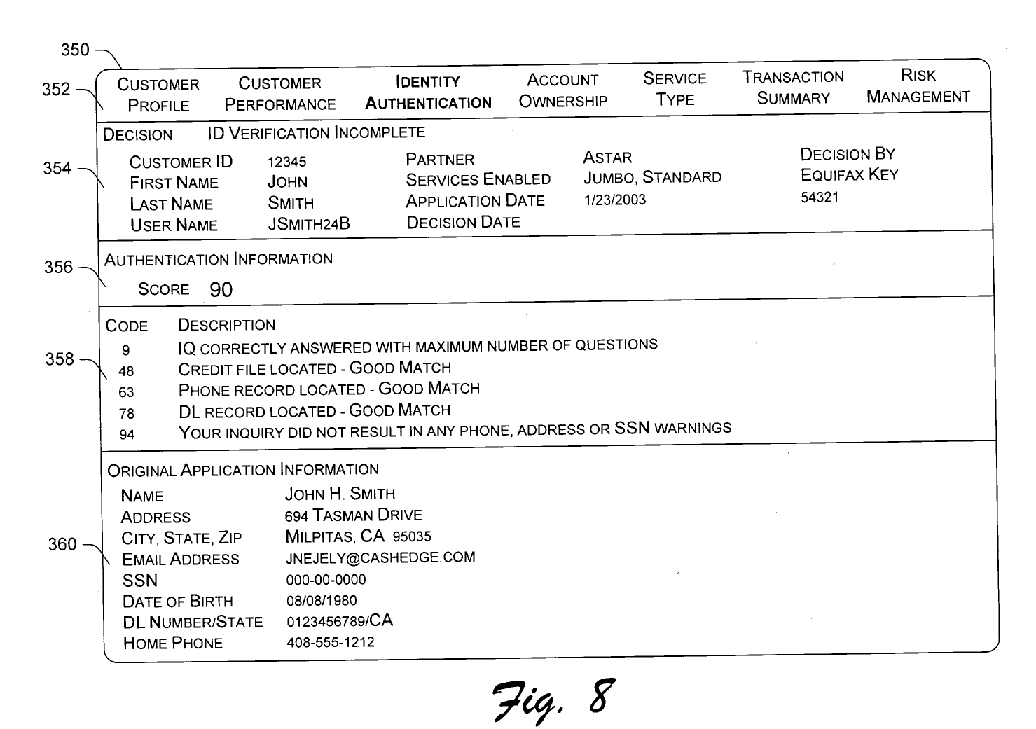

FIG. 8 is an example screen display 350 illustrating information related to identity authentication. Information on display 350 provides an understanding as to how a customer was approved or denied for authentication purposes. Additionally, if authentication documents (e.g., bank statements, voided checks, or phone bills) were requested by the system or by customer selection, additional pages associated with the offline authentication may be displayed. The additional pages display, for example, the status of authentication of the various documents requested.

A menu section 352 shows that the “Identity Authentication” category is selected. A decision section 354 indicates whether ID verification is complete. Additionally, decision section 354 provides an identity of the customer as well as the services that are enabled and how the authentication decision was made (e.g., by “Equifax Key 54321”). An authentication information section 356 identifies the authentication score associated with the customer. This authentication score is based on the results of attempts to authenticate the customer's identity through various sources and methods. The authentication score is used, for example, to set limits on financial transactions that can be executed by the customer and to determine the types of financial transactions that the customer can implement. These limits may include limits on the number of transactions each month, the maximum amount of each transaction, the number of days until the transaction settles, etc.

A code section 358 identifies the reason codes associated with a particular final score. Each reason code has an associated description. An original application information section 360 displays information submitted by the customer on their original application (e.g., an application to utilize the services of the financial transaction system).

Although not shown in FIG. 8, a separate identity authentication detail page may be displayed that includes additional information regarding each attempt to authenticate the identity of the customer. This additional information may include whether the document submitted was legible, whether the document had been altered, the age of the document, whether the customer name was a correct match, whether the customer address was a correct match, etc.

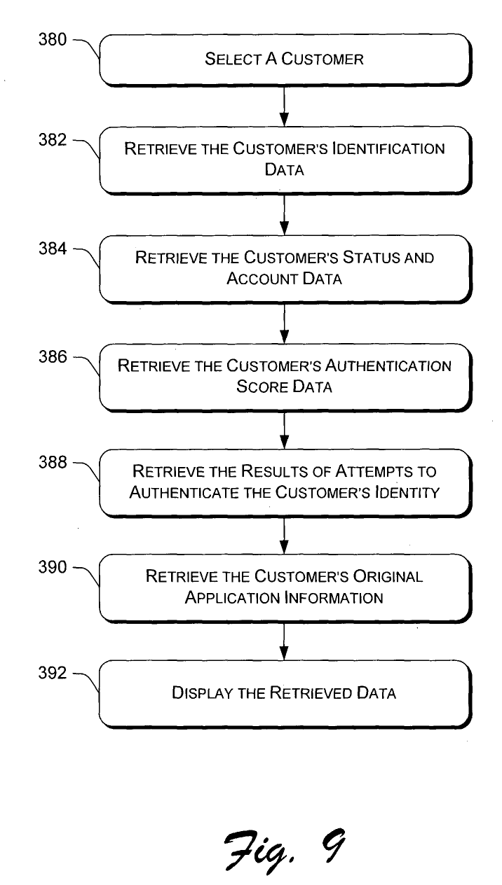

FIG. 9 is a flow diagram illustrating a procedure for generating an identity authentication display of the type shown in FIG. 8. Initially, a particular customer is selected at block 380. The procedure then retrieves the customer's identification data (block 382) as well as the customer's status and account data (block 384). The procedure continues by retrieving and/or calculating the customer's authentication score (block 386) and retrieving the results of attempts to authenticate the customer's identity (block 388). Finally, the procedure retrieves the customer's original application information (block 390) and displays the retrieved data (block 392).

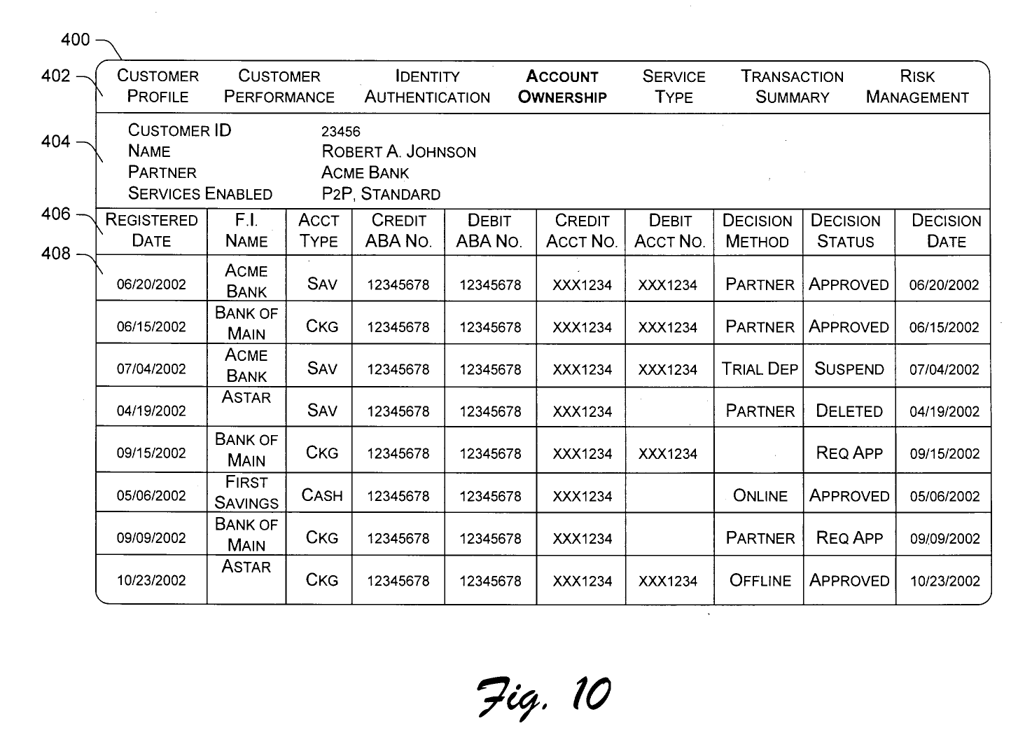

FIG. 10 is an example screen display 400 illustrating information related to account ownership. The display typically includes all of a customer's financial accounts, regardless of the status of those accounts. A menu section 402 includes a highlighted “Account Ownership” category. A customer information section 404 displays various information about the customer, including their customer ID and any services that are enabled for the customer. A section 406 provides column headings for the data that follows in one or more rows 408. These column headings include various account information and account numbers as well as the authentication status of each account listed.

Although not shown in FIG. 10, a separate account ownership detail page may be displayed that includes additional information regarding each of the customer's accounts. This additional information may include how the account was verified, whether certain documents were submitted as part of the verification process, etc.

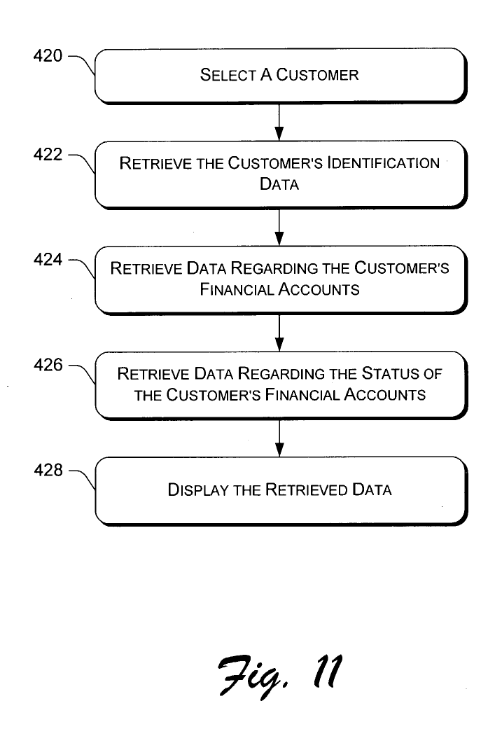

FIG. 11 is a flow diagram illustrating a procedure for generating an account ownership display of the type shown in FIG. 10. The procedure begins by selecting a customer (block 420) and retrieving the customer's identification data (block 422). The procedure then retrieves data regarding the customer's financial accounts (block 424). These financial accounts may be associated with any number of different financial institutions. The procedure finishes by retrieving data regarding the status of the customer's financial accounts (block 426) and displaying the retrieved data (block 428).

Although not shown, a service type screen display may be generated to display the service types that are enabled for a particular customer. This screen display may also include various limits associated with each service type and how much of each service type limit has been used by the customer. Additionally, a transaction summary screen display can be generated to display information regarding a customer's financial transactions. This information may include, for each transaction, the type of transaction, the financial accounts involved in the transaction, the transaction status, the service type, the transaction amount and the entity that assumed the financial risk for the transaction. Additional information regarding assumption of financial risk for a transaction is provided below.

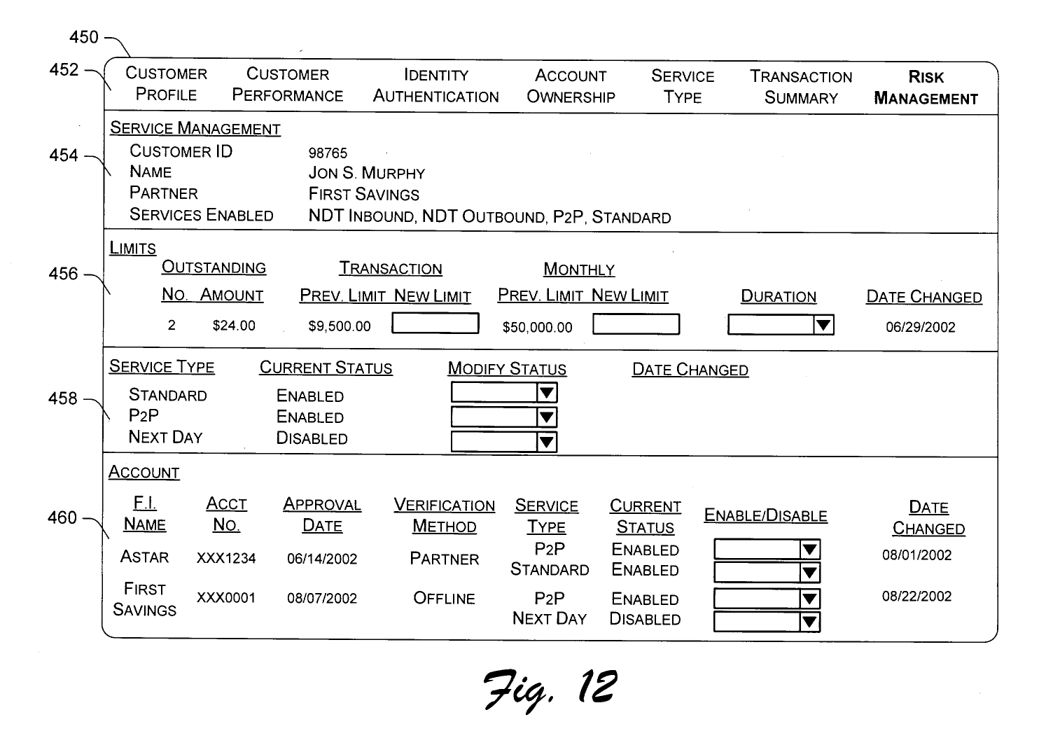

FIG. 12 is an example screen display 450 illustrating information related to risk management. A menu section 452 indicates that the “Risk Management” category has been selected. A service management section 454 identifies the selected customer and the services enabled for that customer. A limit section 456 identifies the number of outstanding transactions, the previous (or current) individual transaction limit, and the previous (or current) monthly transaction limit. Additionally, limit section 456 allows an administrator to modify the individual transaction limit and/or the monthly transaction limit. The administrator can also set the duration of the modification (e.g., for the day, for the month, or permanent). A “Date Changed” heading identifies the last time any of the customer's limits were modified.

A service type section 458 identifies each of the service types available to the customer and the status of each service type. An administrator can modify the status of any of the service types by selecting an appropriate entry from the pull-down menu associated with each service type. Service type section 458 also includes information regarding the date on which the last modification was made.

An account section 460 includes a listing of the customer's accounts and the status of each account. Account section 460 also identifies the verification method used for each account and the service types available for each account. An administrator can modify the settings of each service type for each account using the pull-down menu associated with each account/service type. Account section 460 also includes information regarding the date on which the last modification was made.

Although not shown, additional risk management screen displays allow an administrator to suspend or terminate a customer's financial transaction privileges, reset the customer's password, or modify any other privileges or parameters associated with the customer or the customer's accounts. Other screen displays allow an administrator to override particular limits and restrictions on a customer or a customer's accounts. These changes can be performed in real time such that the changes are implemented within a few seconds, thereby avoiding a delay in entering the changes. Such a delay might prevent a customer from implementing a transaction when desired or might allow a transaction that should have been disallowed.

Various examples discussed herein relate to various user attributes, privileges, and the like. However, these same attributes and privileges may be applied to a group or a role. One or more individuals may be assigned to the group or role, thereby inheriting the attributes and privileges of that group or role. Thus, changes to a single group or role affect all individuals associated with that group or role. Different groups may have different privileges. For example, a member of a “manager” group may be able to override default account access privileges of an account holder. A member of a “product manager” group may be limited to receiving reports and is not permitted to change account access privileges. A member of a “customer service” group may be permitted to make changes within certain guidelines. Any changes outside those guidelines would require manager approval.

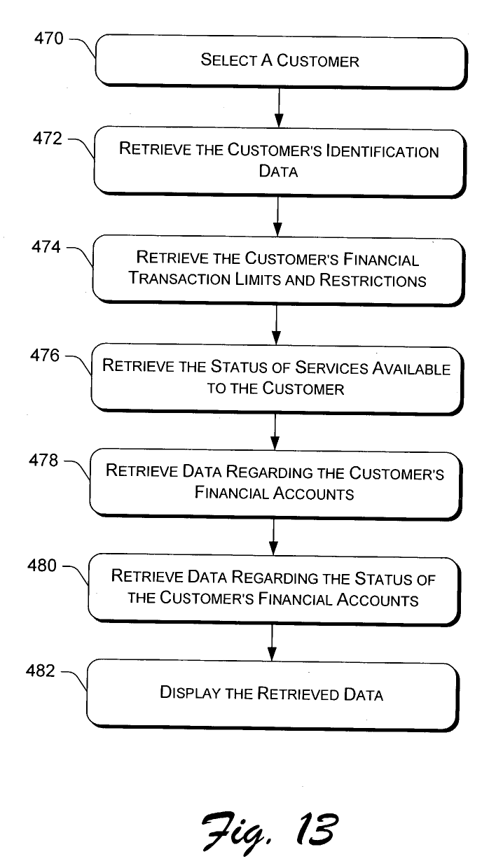

FIG. 13 is a flow diagram illustrating a procedure for generating a risk management display of the type shown in FIG. 12. After selecting a customer (block 470), the procedure retrieves the customer's identification data (block 472). The procedure then retrieves the customer's financial transaction limits and restrictions (block 474) as well as the status of services available to the customer (block 476). Next, the procedure retrieves data regarding the customer's financial accounts (block 478) and retrieves data regarding the status of the customer's financial accounts (block 480). Finally, the procedure displays the retrieved data at block 482.

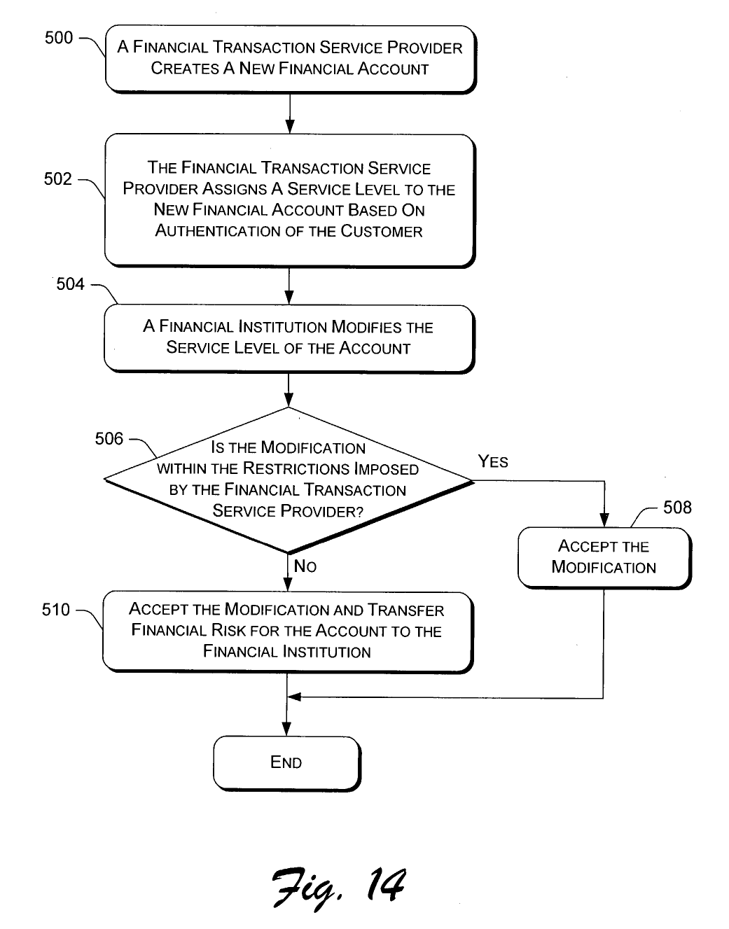

FIG. 14 is a flow diagram illustrating a procedure for shifting financial risk between two entities. Initially, at block 500, a financial transaction service provider creates a new financial account (e.g., for a new customer or an existing customer). The financial transaction service provider assigns a service level to the new financial account based on authentication of the customer and/or the account information supplied by the customer (block 502). If the customer is an existing customer, the service level may be selected to match the service level associated with the customer's existing accounts. The service level defines various transaction limits and account restrictions, such as maximum transaction amounts, settlement times and the types of transactions permitted.

At block 504, a financial institution (or other entity) modifies the service level assigned to the account. Thus, the original service level assigned by the financial transaction service provider has been modified by another entity. The procedure determines whether the modification to the service level is within the restrictions imposed by the financial transaction service provider (block 506). If so, the procedure accepts the modification (block 508). However, if the modifications to the service level are not within the restrictions imposed by the financial transaction service provider, the modifications are accepted but financial risk for the account is transferred to the financial institution or other entity making the modification (block 510). Thus, a financial institution can override the restrictions of the financial transaction service provider, but the financial institution must then accept the financial risks associated with that account.

If the financial institution (or other entity) later changes the service level back to a level that is within the restrictions imposed by the financial transaction service provider, the financial risk for the account transfers back to the financial transaction service provider.

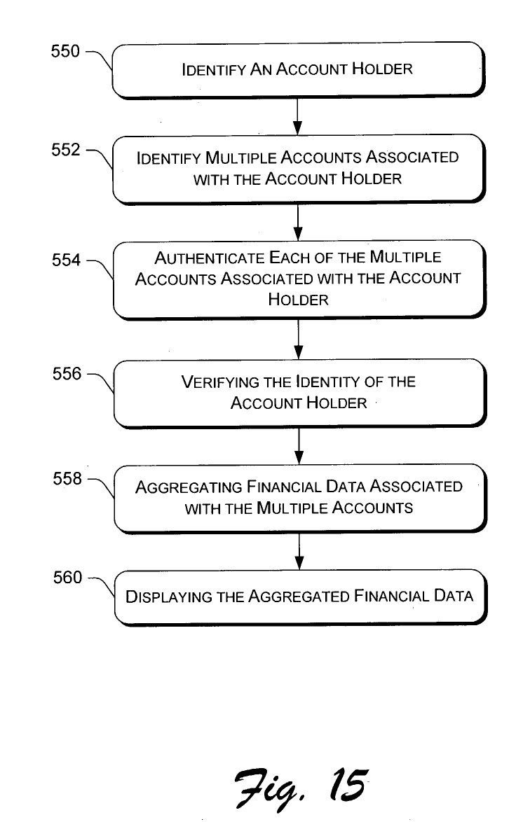

FIG. 15 is a flow diagram illustrating a procedure for aggregating financial data. Initially, the procedure identifies an account holder (block 550). The procedure then identifies multiple accounts associated with the account holder (block 552). These multiple accounts are typically associated with two or more different financial institutions. For example, a typical account holder may have two bank accounts at two different banks, a brokerage account with a brokerage firm, a mortgage account with a mortgage company and a retirement account with a mutual fund company.

The procedure continues by authenticating each of the multiple accounts associated with the account holder (block 554). If one or more of the multiple accounts are not authenticated, information regarding those accounts is not retrieved or displayed. Next, the identity of the account holder is verified (block 556). If the account holder's identity is not verified, data is not displayed to the account holder. If the account holder's identity is verified, the procedure aggregates financial data associated with the multiple accounts (block 558). The aggregated financial data is then displayed (block 560). The aggregated financial data may include any type of information regarding one or more financial accounts, one or more financial institutions, one or more account holders, and the like. The types of financial data displayed include the various types of data discussed herein and illustrated in the accompanying figures.

The various exemplary screens displayed in the accompanying figures and discussed above represent a particular set of data and a particular arrangement of data. The systems and methods described herein can be used to aggregate and display any type of data, from any number of sources.

Although not shown, additional screen displays allow customers and/or administrators to access message boards for exchanging information, questions, etc. Other screen displays include information changes to the customer's address, phone number and email address.

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

1. A method comprising:
identifying an account holder;
identifying a plurality of financial accounts associated with the account holder, wherein the plurality of financial accounts are associated with at least two different financial institutions;
authenticating each of the plurality of financial accounts associated with the account holder;
aggregating financial data associated with the plurality of financial accounts; and
displaying the aggregated financial data.

2. A method as recited in claim 1 further comprising identifying account holder identification data and displaying the identification data with the financial data.

3. A method as recited in claim 1 further comprising identifying status information regarding the identified financial accounts and displaying the status information with the financial data.

4. A method as recited in claim 1 further comprising identifying account holder address data and displaying the address data with the financial data.

5. A method as recited in claim 1 further comprising identifying account holder email address data and displaying the email address data with the financial data.

6. A method as recited in claim 1 further comprising identifying fees collected from the account holder for the financial transactions and displaying the fees with the financial data.

7. A method as recited in claim 1 further comprising identifying risk profile data for the account holder and displaying the risk profile data with the financial data.

8. A method as recited in claim 1 further comprising identifying an authentication score for the account holder and displaying the authentication score identification data with the financial data.

9. A method as recited in claim 1 wherein the financial transaction data includes data regarding a transfer of funds between financial accounts at different financial institutions.

10. A method as recited in claim 1 further comprising displaying the identified financial accounts.

11. A method as recited in claim 1 further comprising generating a report containing the financial data.

12. A method as recited in claim 1 further comprising allowing a user to modify limits on financial transactions associated with the account holder's financial accounts.

13. A method as recited in claim 1 further comprising allowing a user to modify fees charged for financial transactions associated with the account holder's financial accounts.

14. A method as recited in claim 1 further comprising allowing a user to modify a service level associated with the account holder.

15. A method as recited in claim 14 further comprising assigning financial risk for the financial accounts associated with the account holder to an entity changing the service level if the changed service level is not within restrictions originally assigned to the financial accounts.

16. A method as recited in claim 1 wherein authenticating the financial accounts includes retrieving information from a financial institution associated with the financial accounts.

17. A method as recited in claim 1 wherein authenticating the financial accounts includes retrieving information from a credit reporting agency.

18. A method as recited in claim 1 wherein authenticating the financial accounts includes:
retrieving information from a financial institution associated with at least one of the financial accounts; and
retrieving information from a credit reporting agency.

19. A method as recited in claim 1 further comprising verifying the identity of the account holder.

20. A method as recited in claim 1 wherein aggregating financial data includes restricting the data aggregated based on privileges associated with a user that will view the aggregated data.

21. One or more computer-readable memories containing a computer program that is executable by a processor to perform the method recited in claim 1.

22. A method comprising:
identifying an account holder;
identifying a plurality of financial accounts associated with the account holder, wherein the plurality of financial accounts are associated with at least two different financial institutions;
verifying the identity of the account holder;
aggregating financial data associated with the (plurality of financial accounts; and
displaying the aggregated financial data.

23. A method as recited in claim 22 wherein verifying the identity of the account holder includes retrieving information from a credit reporting agency.

24. A method as recited in claim 22 wherein verifying the identity of the account holder includes retrieving information from a driver's license database.

25. A method as recited in claim 22 wherein verifying the identity of the account holder includes retrieving information from a financial payment network.

26. A method as recited in claim 22 further comprising identifying an authentication score associated with the account holder and displaying the authentication score.

27. A computer-implemented method of aggregating financial data, the method comprising:
identifying a first account holder;
identifying a second account holder;
identifying financial transaction data associated with the first account holder;
identifying financial transaction data associated with the second account holder; and
aggregating the financial transaction data associated with the first account holder and the second account holder.

28. A computer-implemented method as recited in claim 27 further comprising allowing a user to modify fees charged for financial transactions associated with the first account holder.

29. A computer-implemented method as recited in claim 27 further comprising displaying data regarding the identity of the first account holder and the second account holder.

30. A computer-implemented method as recited in claim 27 further comprising identifying financial account status information regarding the first account holder and the second account holder and displaying the status information with the financial transaction data.

31. A computer-implemented method as recited in claim 27 further comprising identifying fees associated with the identified financial transactions and displaying the fees with the financial transaction data.

32. A computer-implemented method as recited in claim 27 further comprising:
identifying fees associated with financial transactions of the first account holder;
identifying fees associated with financial transactions of the second account holder; and
displaying the fees associated with the financial transactions of the first account holder and the second account holder.

33. A computer-implemented method as recited in claim 27 further comprising:
identifying a first risk profile associated with the first account holder;
identifying a second risk profile associated with the second account holder; and
displaying the first and second risk profiles with the financial transaction data.

34. A computer-implemented method as recited in claim 27 wherein the financial transaction data includes data regarding funds transfers between different financial institutions.

35. A computer-implemented method as recited in claim 27 further comprising allowing a user to modify limits on financial transactions associated with the accounts of the first and second account holders.

36. A method comprising:
a first entity creating a financial account;
validating the financial account;
associating a service level with the account based on results of validating the financial account;
assigning financial risk for the financial account with the first entity; and
reassigning financial risk for the financial account to a second entity if the second entity changes the service level associated with the financial account such that the changed service level is not within restrictions imposed by the first entity.

37. A method as recited in claim 36 further comprising reassigning the financial risk for the financial account to the first entity if the second entity changes the service level associated with the financial account such that the changed service level is within restrictions imposed by the first entity.

38. A method as recited in claim 36 wherein the first entity is a financial transaction service provider.

39. A method as recited in claim 36 wherein the first entity is a financial institution.

40. One or more computer-readable memories containing a computer program that is executable by a processor to perform the method recited in claim 36.

41. An apparatus comprising:
means for identifying an account holder;
means for identifying a plurality of financial accounts associated with the account holder, wherein the plurality of financial accounts are associated with a plurality of different financial institutions;
means for authenticating each of the plurality of financial accounts associated with the account holder;
means for aggregating transaction data associated with the plurality of financial accounts, wherein the aggregated transaction data includes funds transfers between identified financial accounts associated with different financial institutions; and
means for displaying the aggregated transaction data.

42. An apparatus as recited in claim 41 further comprising means for identifying information associated with the account holder, wherein the means for displaying the identified transaction data further displays the information associated with the account holder.

43. An apparatus as recited in claim 41 further comprising means for modifying limits on financial transactions associated with the identified financial accounts.

44. An apparatus comprising:
a storage device to store account information and financial transaction data;
a search module coupled to the storage device and configured to identify an account holder and multiple financial accounts associated with the account holder and associated with multiple financial institutions; and
a display module coupled to the search module and configured to generate data representing an image that includes financial transaction data associated with at least one account holder and a status of multiple financial accounts associated with the identified one account holder.

45. An apparatus as recited in claim 44 further comprising an update module coupled to the storage device and configured to modify a service level associated with the at least one account holder.

46. An apparatus as recited in claim 44 further comprising an update module coupled to the storage device and configured to modify a service level associated with at least one of the account holder's financial accounts.

47. A method as recited in claim 1 further comprising allowing a user to modify limits on financial transactions associated with the account holder's financial accounts.

48. One or more computer-readable media having stored thereon a computer program that, when executed by one or more processors, causes the one or more processors to:
identify an account holder;
identify accounts associated with the account holder;
identify financial transactions associated with the identified accounts;
authenticate the identified accounts;
verify the identity of the account holder;
identify risk profile data associated with the account holder; and
display the financial transactions and the risk profile data if the account holder is verified.

49. One or more computer-readable media as recited in claim 47 wherein the financial transactions include a transfer of funds between accounts associated with different financial institutions.
